(19) United States
(12) Patent Application Publication
(10) Pub. No.: US 2007/0141097 A1
(43) Pub. Date: Jun. 21, 2007

(54) Packaging means for emanating pyrethroid effective in controlling flying insects

(75) Inventors: Krishanthi Balakrishnan, West Ryde (AU); Gary Raymond Bowman, West Ryde (AU); Rosita Junus, West Ryde (AU); Bruce Graham Kemmis, Thornleigh (AU); Alan John Morris, Ascot Vale (AU); Philip Stephen Ridley, Glenbrook (AU); Ian Andrew Thompson, West Ryde (AU)

Correspondence Address: MERCHANT & GOULD PC, P.O. BOX 2903, MINNEAPOLIS, MN, 55402-0903, US

(73) Assignee: Reckitt Benckiser (Australia) Pty Limited, West Ryde (AU)

(21) Appl. No.: 10/577,910

(22) PCT Filed: Oct. 15, 2004
(86) PCT No.: PCT/GB04/04369

§ 371 Date: Jan. 12, 2007

(30) Foreign Application Priority Data
Nov. 7, 2003 (GB) 0326056.9

(51) Int. Cl. A01N 65/00

(52) U.S. Cl. 424/405; 514/65

(57) ABSTRACT

The invention provides a packaging means for retaining vapour active pyrethroids comprising a holder and a cellulosic based substrate or matrix impregnated and/or dosed with the vapour active pyrethroid, wherein the holder comprises a topl), a bases and a longitudinal member vertically extending from between the topw and base, and wherein the cellulosic matrix has a honeycomb configuration adapted to be retained between the top and base and has a surface area so as to achieve sufficient emanation of the vapour active pyrethroid to control flying insects. The invention also provides methods of emanating vapour active pyrethroids and the use of packaging means according to the invention for retaining and emanating vapour active pyrethroids.

### TECHNICAL FIELD

The present invention relates generally to insect control and more particularly a packaging means for retaining and emanating vapour active pyrethroid that is effective in controlling flying insects, particularly mosquitoes.

### BACKGROUND ART

The control of flying insects in an indoor or an outdoor area has traditionally been achieved using articles or devices that dispense insecticide vapours into the atmosphere. Such articles or devices generally burn or heat a liquid or solid substrate to vaporise the active ingredient. For instance, in controlling mosquitoes, coils impregnated with an active ingredient are burnt so that heat from combustion causes the release of the active ingredient into the atmosphere, citronella oil candles are burnt so as to heat the citronella oil and allow it to evaporate into the atmosphere, while electric devices electrically heat the active ingredient so that it vaporises and is dispersed into the atmosphere. Battery operated, fan driven products are also used to control mosquitoes. The above mentioned products require an energy source in the form of combustion, heat or electricity. The release rates of active insecticides from continuous action products such as mosquito coils, candles, liquid vaporisers and electrically heated mats are essentially independent of the surrounding environment as the driving force for discharge of the active is supplied from within the system.

The abovementioned articles and devices used to control mosquitoes have disadvantages. The combustion of mosquito coils requires a safe burning site and results in ash and smoke. The burning of a candle exposes a naked flame and therefore requires a safe burning site, while the use of electricity to heat an insecticidal device is costly in some developing countries and is not portable.

There also exists ambient temperature moth repellent products that rely on passive evaporation of the insecticide from a substrate into the environment. These products, which have commonly been used to control moths, do not require an external source of energy, such as combustion, heat or electricity to release the insecticide into the atmosphere. Instead, an insecticide that vapourises at ambient temperature is required for these products. The concept of an ambient temperature moth repellent has many benefits: they provide long lasting and continuous protection; they are efficient in that there is no need for a means of heating; they are portable, modern and practical.

The above known ambient temperature products, however, also have disadvantages. Firstly, many of the prior art products are only effective in small, enclosed spaces and require significant air movement for the insecticide to be effective in a larger area of space. Secondly, there is a short falling in the number of cost-effective products that are able to work efficiently using low doses of insecticide for the control of insects other than moths, such as mosquitoes.

In attempting to address the above short comings, the present inventors found an effective way for controlling insects, in particular mosquitoes, using a combination of substrate and a vapour active pyrethroid that allows passive emanation of the pyrethroid from the substrate at dose levels that achieve a minimum effective emanation rate and are cost effective. These findings have been described previously in an application by the same applicants, the contents of which are attached as Appendix A. Such products involving a substrate and a vapour active pyrethroid as developed by the present inventors, or indeed any of the above discussed known ambient temperature products, typically take the form of a flat substrate or a concertina-type arrangement having a number of honeycomb-like cells. The concertina-type arrangements are able to be expanded through 180° to 360° and be opened on a table to provide a bridge or fan configuration or closed into a circle to give a hanging lantern configuration or be hung to give a linear lantern configuration. There are, however, a number of disadvantages associated with such arrangements: In for instance the flat substrate arrangements, due to their flat configuration, the available surface area from which active ingredient is able to be emanated is small. As such, low rates of emanation to the atmosphere are observed. In the case of the bridge or fan configuration, the honeycomb-like cells on the extreme ends of the fan are not fully expanded thereby leading to an inefficient use of available (or potential) surface area from which active ingredients are able to emanate. As such, lower rates of emanation to the atmosphere are observed. In the case of the hanging circular or linear configurations, these require some means of attachment, such as a hook, that will allow these to be hung to a wall or ceiling. Clearly, from a consumer point of view, having to attach a hook to a ceiling or a wall in order to allow the lantern to be hung is both time consuming and laborious and therefore undesirable. In addition, in configurations that are to be hung against the wall, reduced rates of emanation are observed due to the limited air flow around and through the substrate.

Whilst recognising the short comings of prior art articles for controlling mosquitoes and moths, the present inventors have sought to provide an improved packaging means for retaining and emanating vapour active pyrethroids that is able to achieve improved rates of emanation.

### DISCLOSURE OF THE INVENTION

The present inventors have found that imparting verticality (or height) to the substrate results in a higher rate of emanation of the pyrethroid and therefore more efficient insect control.

In a first aspect, the present invention is directed a packaging means for retaining vapour active pyrethroids comprising a holder and a cellulosic based substrate or matrix impregnated and/or dosed with the vapour active pyrethroid, wherein the holder comprises a top, a base and a longitudinal member vertically extending from between the top and base, and wherein the cellulosic matrix has a honeycomb configuration adapted to be retained between the top and base and has a surface area so as to achieve sufficient emanation of the vapour active pyrethroid to control flying insects.

In a second aspect, the invention provides a packaging means for retaining vapour active pyrethroids comprising a holder and a cellulosic based substrate or matrix impregnated and/or dosed with the vapour active pyrethroid, wherein the holder comprises a top, a base and a longitudinal member vertically extending from between the top and base, and wherein the cellulosic matrix has a honeycomb configuration adapted to be retained between the top and base and has a surface area so as to achieve sufficient emanation of the vapour active pyrethroid to control flying insects, and wherein the cellulosic substrate or matrix is comprised of two or more discrete parts. It has been observed that according to the second aspect of the invention, increased emanation of vapour active pyrethroid is achieved through the use of two or more discrete cellulosic substrates or matrices. Although not wishing to be bound by theory, it is believed that the increased rate of emanation is achieved by the ability of the surrounding air/atmosphere to access the regions between the one or more discrete parts. In a particularly preferred embodiment, the cellulosic substrate or matrix is comprised of two discrete parts.

The longitudinal member extending from between the holder top and base is preferably able to be releasably attached to the top and base and may be in the form of a column or a spring. When in the form of a column, preferably the column is collapsible by folding at one or more hinged joints, however the column may be comprised of one or more parts which are collapsible by telescopic movement of the one or more parts of the column within the other parts of the column. Alternatively, the column may be comprised of two or more releasably interfitting parts that are able to be interfitted by means of a slotted configuration that are able to be detached from each other as well as the top and the base, and stored in the base. In yet a further alternative arrangement, the holder top is adapted to slide along the column thereby allowing the holder to be open and closed as required. When the longitudinal member extending from between the holder top and base is in the form of a spring, the spring may be compressed in the resting state so that the cellulosic based substrate or matrix is maintained in a collapsed state in the absence of an externally applied force. Alternatively, the spring may be uncompressed in the resting state so that the cellulosic based substrate or matrix is maintained in an extended state in the absence of an externally applied force. Preferably also, the longitudinal member is capable of being stored within the packaging means when the top and base are in a closed position.

Desirably, the holder and the cellulosic based substrate or matrix are adapted to allow the cellulosic matrix to be releasably retained in the holder and replaced as required. This may be achieved by the provision of a slot within the periphery of each of the top and base and a card on each end of the cellulosic based substrate or matrix, wherein the cards are able to be slid into the slots thereby allowing the cellulosic based substrate or matrix to be releasably attached to the holder. This configuration has the advantage of allowing the cellulosic based substrate or matrix to be replaced without the need to detach the longitudinal member from the top or base while the top and base are in the closed or open state. It is also envisaged that the cellulosic based substrate or matrix may be adapted to receive the longitudinal member through an aperture thereby retaining the cellulosic based substrate or matrix between the top and base. In this configuration, the cellulosic based substrate or matrix is able to be replaced by detaching the top or base, or both, from the longitudinal member, mounting the cellulosic based substrate or matrix about the longitudinal member, and reattaching the top or base, or both, to the longitudinal member.

In a preferred embodiment of the invention, the cellulosic based substrate or matrix is attached to the top and base, wherein the base is able to be surface-mounted and is connected to the longitudinal member having a hook on its end, and wherein the cellulosic substrate or matrix is able to be extended and supported in the extended state by attachment of the top to the hook. Preferably, the top is able to be attached to the hook by means of a ring located on the top.

In yet another particularly preferred embodiment of the invention, the packaging means further comprises an end-of-life (EOL) indicator. The indicator displays the number of times that the product has been in use through a dial indication (counter) that rotates one increment or ‘use period’ by means of a toothed gearing system each time a user opens the packaging means. This indicator also displays to the user when the product is nearing end-of-life.

In a third aspect, the invention provides a cellulosic based substrate or matrix having a honeycomb structure that when in an extended state, has an effective emanation surface area of about 50-5000 cm² and a height of about 8-23 cm. Preferably the height is about 17.5 cm.

In a fourth aspect, the invention provides a method of emanating a vapour active pyrethroid into the atmosphere by the use of a packaging means for retaining vapour active pyrethroids comprising a holder and a cellulosic based substrate or matrix impregnated and/or dosed with the vapour active pyrethroid,

wherein the holder comprises a top, a base and a longitudinal member vertically extending from between the top and base, and

wherein the cellulosic based substrate or matrix has a honeycomb configuration adapted to be retained between the top and base and has a surface area so as to achieve sufficient emanation of the vapour active pyrethroid to control flying insects.

In a fifth aspect, the invention is directed to the use of a packaging means for retaining and emanating vapour active pyrethroids comprising a holder and a cellulosic based substrate or matrix impregnated and/or dosed with the vapour active pyrethroid,

wherein the holder comprises a top, a base and a longitudinal member vertically extending from between the top and base, and

wherein the cellulosic based substrate or matrix has a honeycomb configuration adapted to be retained between the top and base and has a surface area so as to achieve sufficient emanation of the vapour active pyrethroid to control flying insects.

It is desirable that the cellulosic based substrate or matrix is substantially sealed when the packaging means is in the closed state so that a minimal amount of vapour active pyrethroid is emanated into the atmosphere. This may be achieved with a protruding rim on the top and a means for engaging the protruding rim on the base to substantially seal the vapour active pyrethroid when the top and base are in the closed state. Most preferably, the top is a lid.

It will be appreciated that the packaging means in accordance with the present invention may be provided to a user with or without the cellulosic based substrate or matrix- In this way, the cellulosic based substrate or matrix, in accordance with the present invention, is envisaged as a refill product that is readily able to be attached or detached as desired and replaced for example, upon depletion of the impregnated and/or dosed vapour active pyrethroid. The means of attachment may be by the use of cards (glued, stapled or otherwise attached by any conventional means known to the skilled person), to the ends of the cellulosic substrate, wherein the holder and cards are adapted so that the cards are capable of being held between the holder top and base. Alternatively, the cellulosic based substrate or matrix may be directly fixed to the top and base by means of, for example, clips, hook and loop fasteners (velcro®) or staples.

According to the various aspects of the invention, 0 emanation of the vapour active pyrethroid from the cellulosic based substrate or matrix into the air controls flying insects. It will be understood that “control” of the flying insect population includes but is not limited to any one of or a combination of killing, repelling or knocking down a flying insect. It will be appreciated that a typical way of measuring the performance of an insecticide is in the form of “knockdown”

The phrase “surface area” is intended to mean the geometric surface area or the two dimensional surface area of the cellulosic based substrate or matrix. For instance, in a preferred embodiment where the cellulosic based substrate or matrix is paper, the surface area is the total area of both sides of the paper. Generally, the inventors have found that an increase in the surface area, particularly the effective emanation surface area, increases the emanation rate of the vapour active pyrethroid from the cellulosic based substrate or matrix into the atmosphere. It will be understood that the effective emanation surface area is the area of the cellulosic based substrate or matrix that allows emanation of the pyrethroid into the atmosphere. For instance, the inventors have found that increasing the number of folds in a paper substrate reduces the emanation rate of the pyrethroid from the paper substrate.

The term “height” of the cellulosic based substrate or matrix is intended to mean the height of the cellulosic matrix when extended in an open position; that is, the height of the cellulosic matrix extending between the holder top and base.

The cellulosic based substrate or matrix may be any substrate or matrix that contains cellulosic fibres and includes but is not limited to ground wood pulp, chemical 0 wood pulp, straw preferably wheat straw, bagasse (residue from crushed sugarcane), esparto grass, bamboo, flax, hemp, jute and kenafrag fibres (cotton), cotton linters and recycled wastepaper in the form of, for instance, tissue, paper and cardboard. The cellulosic based substrate or matrix may be of varying grade and includes but is not limited to bleached, recycled and virgin cellulosic based substrates or matrices. It will be appreciated that different types of cellulosic based substrates or matrices will affect the emanation rate of the vapour active pyrethroid from the substrate or matrix into the atmosphere. Preferably, the cellulosic based substrate or matrix is paper, more preferably, bleached paper.

It will be understood that a “substrate” is something which underlies or serves as a basis or foundation and a “matrix” is something which gives origin or form to a thing or which serves to enclose it. Accordingly, it will be appreciated that the term “substrate” is more applicable to flat cellulose based articles while the term “matrix” is more applicable to three-dimensional cellulose based articles.

Preferably, the cellulosic based substrate or matrix has a grammage in the range of approximately 12 gsm to 260 gsm, more preferably in the range of approximately 18 gsm to 40 gsm. Most preferably, the cellulosic based substrate or matrix has a grammage of approximately 18 gsm.

The cellulosic based substrate or matrix is impregnated and/or dosed with a vapour active pyrethroid. The substrate or matrix is deemed “impregnated” with the vapour active pyrethroid when the pyrethroid is either partially or completely distributed within the material of the substrate or matrix in such a manner that the pyrethroid fills all or some of the interstices of the material of the substrate or matrix and is directly held within the substrate or matrix and supported thereby. The substrate is deemed to be “dosed” with the vapour active pyrethroid when a specific quantity of the pyrethroid is applied to the substrate or matrix and absorbed either partially or completely into the pores of the substrate or matrix.

The cellulosic based substrate or matrix is impregnated and/or dosed with vapour active pyrethroid in an amount of approximately 2.0-3000 mg/m². It will be appreciated that the amount of vapour active pyrethroid required per square metre will depend on the period of time the vapour active pyrethroid is required to emanate from the cellulose based substrate or matrix. For instance, for a cellulosic based substrate required to be effective in controlling insects, such as mosquitoes, over a 100 hour period, it is preferred that the cellulosic substrate or matrix be impregnated and/or dosed with vapour active pyrethroid in an amount of approximately 16-320 mg/M², more preferably 130-320 mg/m ². Over a 300 hour period, it is preferred that the cellulosic substrate or matrix be impregnated and/or dosed with vapour active pyrethroid in an amount of approximately 48-960 mg/m²₁ more preferably 390-960 mg/m². Over a 900 hour period, it is preferred that the cellulosic substrate or matrix be impregnated and/or dosed with vapour active pyrethroid in an amount of approximately 144-2880 mg/m², more preferably, 1170-2880 mg/m².

The emanation rate of the vapour active pyrethroid from the cellulosic based substrate into the atmosphere will be understood to mean the depletion of an amount of vapour active pyrethroid from the cellulosic based substrate or matrix over a certain period of time. The inventors have found that the emanation rate is affected by the surface area of the cellulose based substrate or matrix, the duration of emanation being determined by the amount of the vapour active pyrethroid applied to the substrate or matrix.

It will be appreciated that one or more vapour active pyrethroids may be employed in the present invention. It will be understood that vapour active pyrethroids are those that are volatile at ambient temperature without heat or combustion. The volatile pyrethroids are preferably selected from the group consisting of metofluthrin transfluthrin, empenthrin, methothrin, tefluthrin and fenfluthrin. Preferably, the vapour active pyrethroid is metofluthrin. Metofluthrin has high potency against mosquitoes, flies, and moths. The chemical name of metofluthrin is 2,3,5,6-tetrafluro-4-(methoxymethyl)benzyl(EZ)-(1RS,3RS;1RS,3SR)-2,2-dimethyl-3-(prop-1-enyl)cyclopropanecarboxylate. Metofluthrin is available from Sumitomo Chemical Company.

Insects within the context of the invention include, but are not limited to, biting Dipterous pests (Order Diptera) such as mosquitoes (Family Culicidae), biting midges (Family Ceratopogonidae), black flies (F. Simulidae), sandflies (certain Psychodidae) and biting flies (various families e.g. some Muscidae and Tabanidae), but may also include non-biting Dipterous insects (e.g. flies and midges of various families including Muscidae, Calliphoridae, Drosophilidae, Chironomidae and Psychodidae), as well as certain moths (Order Lepidoptera).

In the context of the present invention, the inventors have found that paper thickness and type will affect the emanation rate. Further, they have found that increasing the level of vapour active pyrethroid will increase the duration of emanation. Also increasing the surface area, increasing the temperature and increasing the air flow will increase the emanation rate, while folding the paper will decrease the emanation rate.

The holder and the cellulosic based substrate or matrix containing the pyrethroid may be folded between an open form and a closed form such that they are expandable or are re-closable structures. This means that when insect control is not required, the holder and/or the cellulosic based substrate or matrix may be closed and stored in a form which minimises the surface area containing the vapour active pyrethroid that is exposed to the atmosphere. Conversely, when insect control is required, the holder and/or the cellulosic based substrate or matrix may be expanded into an open form thereby increasing the surface area of cellulosic based substrate or matrix containing the pyrethroid that is exposed to the atmosphere allowing the pyrethroid to emanate into the atmosphere. It is also envisaged that the- amount of vapour active pyrethroid emanated into the atmosphere may be controlled by maintaining the top and base in an intermediate state between the open and closed states so that the cellulosic based substrate or matrix is in a partially expanded form.

It will be appreciated that the cellulosic based substrate or matrix is a three dimensional structure having a plurality of cells such as honeycomb like arrangements. It will also be appreciated that the cellulosic based substrate or matrix has two ends. Preferably, the two ends of the cellulosic based substrate or matrix are in contact with material through which the vapour active pyrethroid cannot migrate and/or be absorbed. Preferably, the two ends of the cellulosic based substrate or matrix are attached to a card (for example, cardboard lined with polymer film or with aluminium foil), such that the cellulosic based substrate or matrix impregnated and/or dosed with the active pyrethroid is in contact with the polymer film or foil side of the cardboard.

The present invention will now be described in detail with reference to a number of preferred embodiments as illustrated in the accompanying drawings.

### BRIEF DESCRIPTION OF THE DRAWINGS

FIG. 1 depicts a packaging means according to an embodiment of the invention wherein the top and base are in the open state within which the cellulosic based substrate or matrix is retained.

FIG. 2a depicts an exploded view of the packaging means when in a closed state according to another embodiment of the invention wherein the longitudinal member is in the form of a column that is collapsable by disassembly about a slotted configuration. Shown is the holder top, the cellulosic cartridge, and the holder base within which the disassembled longitudinal member is stored.

FIG. 2b depicts the packaging means according FIG. 2a in the open state within which the cellulosic based substrate or matrix is retained.

FIG. 2c depicts the packaging means according to FIG. 2a in the open state without the cellulosic based substrate or matrix.

FIG. 3a depicts an exploded view of the packaging means when in a closed state according to further embodiment of the invention wherein the longitudinal member is in the form of a spring. Shown is the holder top, the cellulosic cartridge, and the holder base within which the spring is stored in a compressed state.

FIG. 3b depicts the packaging means according to FIG. 3a in an open state within which the cellulosic based substrate or matrix is retained.

FIG. 3c depicts the packaging means according to FIG. 3a in an open state without the cellulosic based substrate or matrix.

FIG. 4a depicts a packaging means when in a closed state according to another embodiment of the invention wherein the longitudinal member is in the form of a column about which the tower is able to be moved along in a sliding motion wherein the column further comprises an indicator.

FIG. 4b depicts the packaging means according to FIG. 4a showing a cutaway view of the column and indicator mechanism.

FIG. 4c depicts an exploded view of the packaging means according to FIG. 4a.

FIG. 4d depicts the packaging means according to FIG. 4a in the open state within which the cellulosic based substrate or matrix is retained.

FIG. 4e depicts the packaging means according to FIG. 4a in the open state without the cellulosic based substrate or matrix.

FIG. 4f depicts the packaging means according to FIG. 4a in the closed state with the cellulosic based substrate or matrix, also in the closed state, ready for insertion into the holder between the top and base.

FIG. 5a depicts a perspective view of the packaging means according to another embodiment of the invention wherein the base is surface-mounted and the cellulosic matrix is attached to the base and top and is able to be retained in the extended state by means of a hook located on one end of the longitudinal member to which the top is able to be attached.

FIG. 5b depicts a rear view of the packaging means according to FIG. 5a.

FIG. 5c depicts a side view of the packaging means according to FIG. 5a.

FIG. 6a depicts a perspective view of a packaging means in an open state according to another embodiment of the present invention wherein the cellulosic based substrate or matrix is comprised of two discrete parts.

FIG. 6b depicts the packaging means of FIG. 6a in a closed state.

FIG. 6c depicts a perspective view of the cellulosic based substrate or matrix comprised of two discrete parts.

FIG. 6d depicts a front view of the cellulosic based substrate or matrix according to FIG. 6c.

FIG. 6e depicts a side view of the cellulosic based substrate or matrix according to FIG. 6c.

FIG. 7 depicts a perspective view of a packaging means inma closed state according to another embodiment of the present invention in which the column is comprised of two interfitting parts.

### DETAILED DESCRIPTION OF THE INVENTION

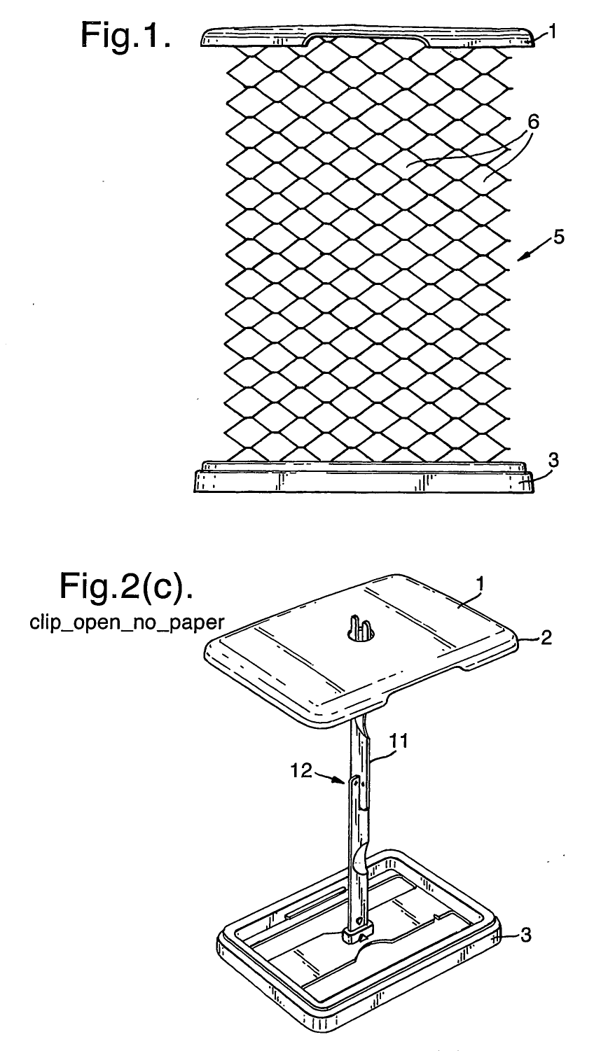

Referring to FIG. 1, a packaging means according to a preferred embodiment of the invention is shown comprising a top (1), a base (3) and a cellulosic based substrate or matrix (5) retained between the top (1) and the base (3). The cellulosic based substrate or matrix (5) is a three dimensional structure with a plurality of cells (6) such as honeycomb like shapes and a concertina type configuration having two ends which are attached to the top (1) and base (3). The cellulosic based substrate or matrix (5) may be any substrate or matrix that contains cellulose and includes but is not limited to tissue, paper, cardboard and rice paper. The cellulosic based substrate or matrix (5) may be of varying quality and includes but is not limited to bleached, recycled and virgin cellulosic based substrates or matrices. It will be appreciated that different types of cellulosic based substrates or matrices will affect the emanation rate of the vapour active pyrethroid from the substrate or matrix into the atmosphere. Preferably, the cellulosic based substrate or matrix (5) is paper, more preferably, bleached paper.

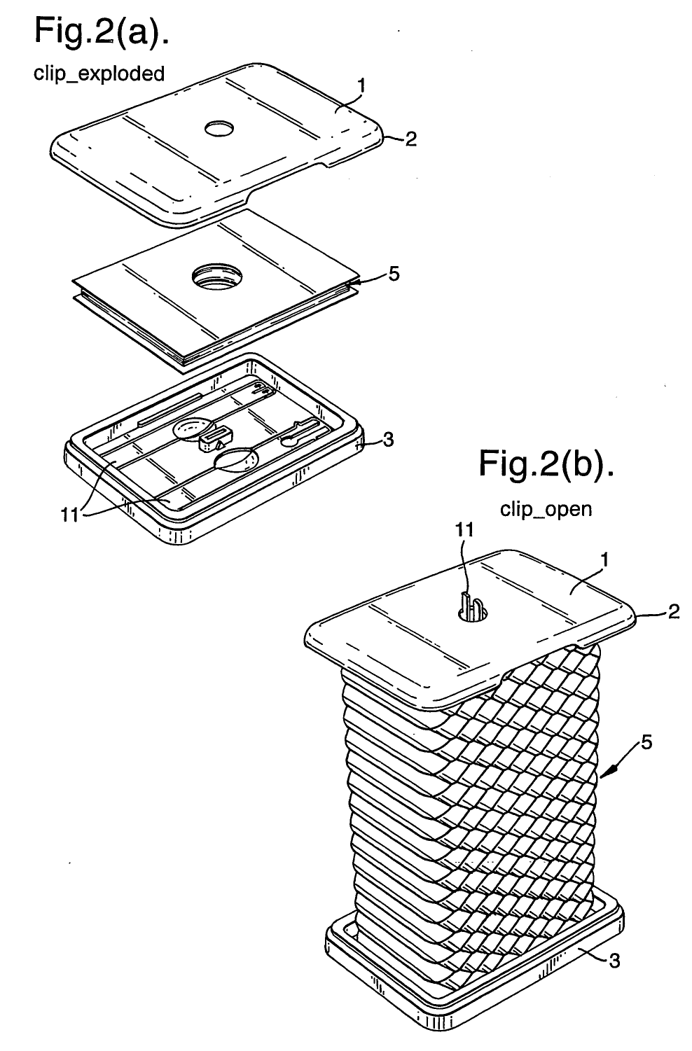

FIG. 2a is directed to a packaging means according to another embodiment of the invention, this time showing detail of the longitudinal member (11) which is disassembled and stored in the base (3). FIG. 2(b) shows the packaging means in an open state wherein the cellulosic based substrate or matrix (5) is retained between the top (1) and base (3). The longitudinal member (11), in this case a column that is able to be disassembled by virtue of a slotted configuration (12), is clearly shown in FIG. 2(c) in the absence of the cellulosic based substrate or matrix.

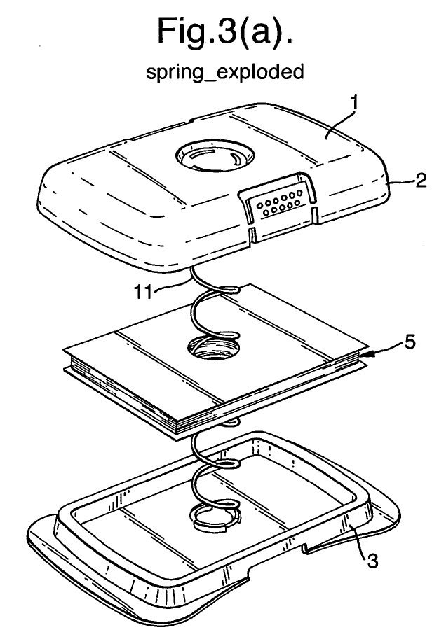

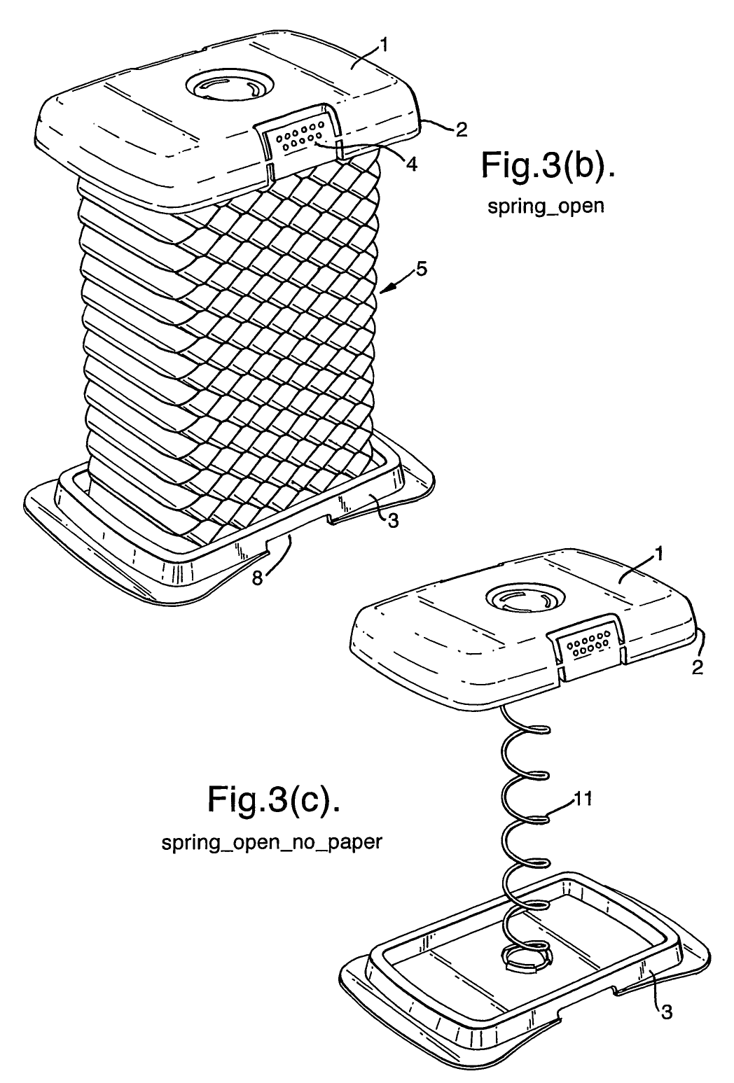

A further embodiment according to the present invention is depicted in FIGS. 3(a)-3(c) wherein the longitudinal member (11) is a spring. In this embodiment, the spring is expanded in the resting state and as such, the top (1) has a latch (4) which clips onto a groove (8) in the base (3) thereby allowing the top and base to be maintained in the closed state.

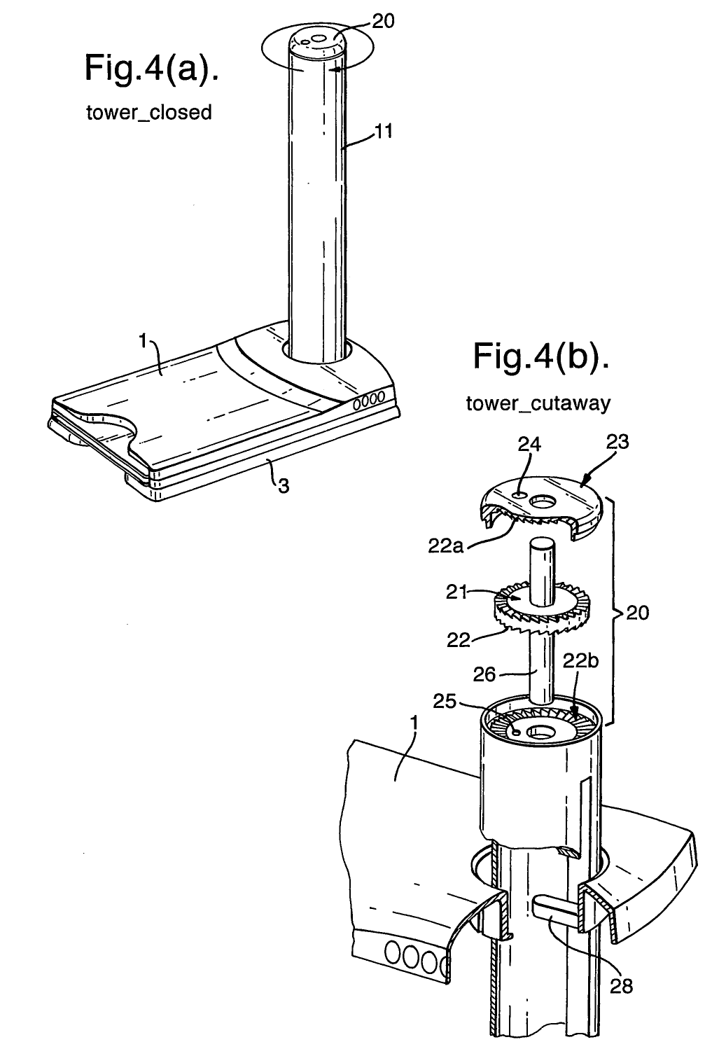

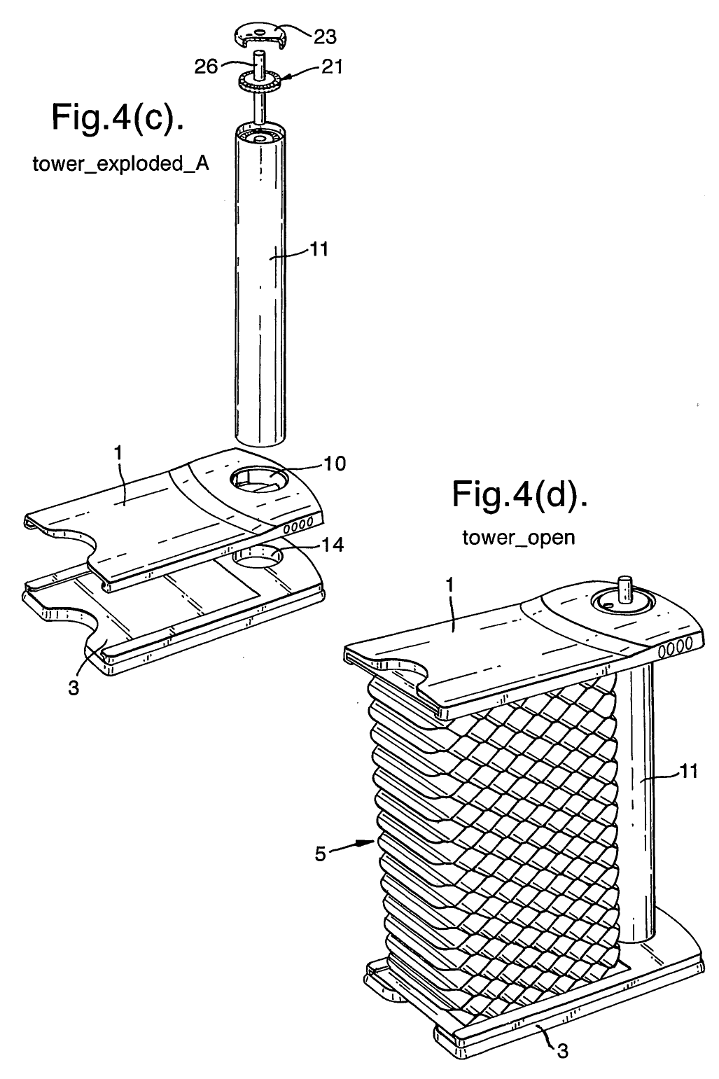

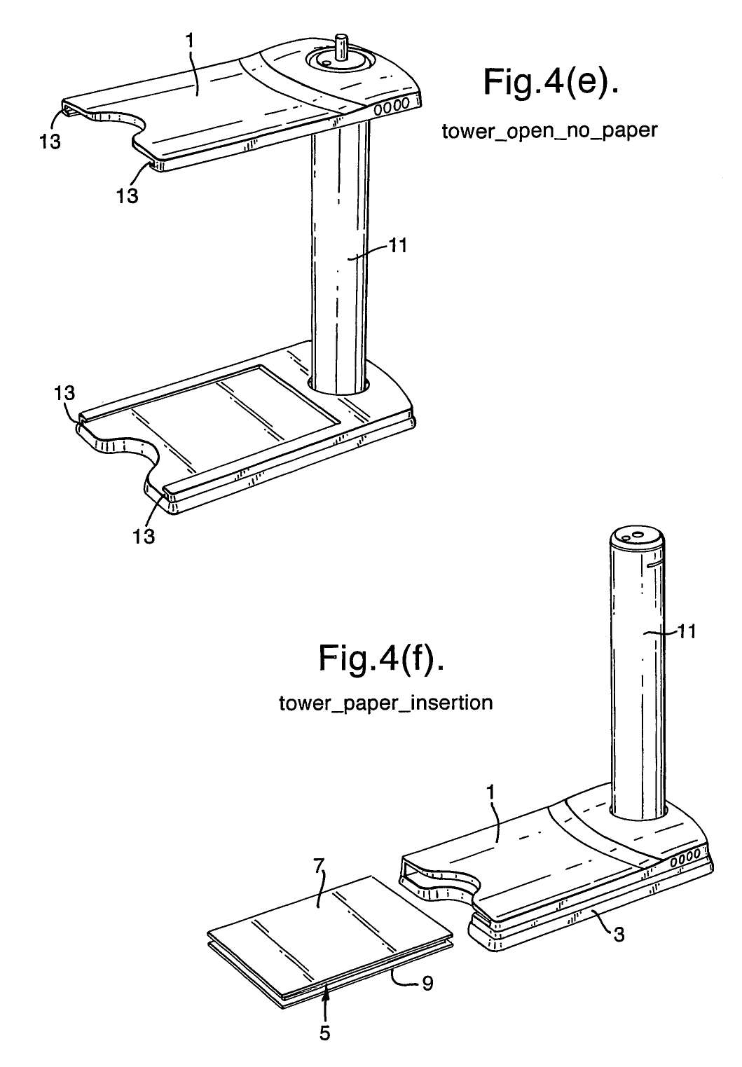

A further embodiment according to the present invention is depicted in FIGS. 4(a)-4(f) wherein the longitudinal member (11) is a column that is not collapsable. The top of the column comprises an indicator (20) the mechanism of which is shown in an exploded and cutaway view in FIG. 4(b). In this embodiment, the top (1), by virtue of an aperture (10) (the aperture (10) is clearly depicted in FIG. 4(c)), is moved towards the base (3) by sliding motion along the column (11) in order to close the holder and the attached cellulosic based substrate or matrix (5). The cellulosic based substrate or matrix (5) may be attached to the top (1) and base (3) by any conventional means known to persons skilled in the art, however, one preferred method is the use of a cards (7, 9) attached to both ends of the cellulosic matrix which may be clipped or otherwise held in position, such as by means of glue or staples. A particularly preferred method of attaching the cellulosic based substrate or matrix (5) is depicted in FIGS. 4(e) and 4(f) in which the top (1) and base (3) comprise slots (13) along the periphery that allows the sliding in of cards (7, 9) to thereby retain the cellulosic based substrate or matrix (5) into position. Advantageously, and as is shown in FIG. 4(f), this arrangement allows the cellulosic based substrate or matrix (5) to be replaced while it, and the holder, is in the closed position.

Referring now specifically to FIG. 4(b), in this particularly preferred embodiment, the EOL indicator (20) is actuated by the opening and closing of the holder. The user of the product sets a counter located at the top of the column to the life period of the product depending on the dosage of the cellulosic based substrate or matrix with vapour active pyrethroid, for example 100 hours, by counterclockwise rotation of the counter. The counter then rotates in the clockwise direction towards zero with each opening and closing of the holder. Progress towards end-of-life is indicated, preferably by graphical means, through a window (24) located at the top of the column (11). The graphic area, visible through the window (24), is printed on a disc (21) that rotates slowly with each opening and closing of the holder. In this way, indication of EOL is able to be represented by, for example, a series of dots of changing (increasing or decreasing) size, numerical means, a change or gradation in colour or combinations of any of such representations. The upper and lower faces of the disc (21) have a mirror image saw-toothed gear profile (22) and the disc (21) is retained in a cylindrical enclosure located at-the top of the column (11) with a spindle (26) providing lateral location through a hole located on a disc (25) that defines the enclosure floor, and a hole in a cap (23) that covers the cylindrical enclosure. Both the enclosure floor (disc (25)) and the underside of the cap (23) also have saw-toothed gear profiles (22a, 22b). The gears on the disc (21) can exist in one of three states: (i) engaged with the gear teeth (22b) located on disc (25), (ii) engaged with the gear teeth (22a) located on the underside of the cap (23), or (iii) in a neutral position between the gear teeth (22a, 22b) of cap (23) and disc (25) wherein this position allows the user to reset the EOL mechanism.

During operation, the holder is preferably opened at night to allow emanation of the vapour active pyrethroid when insect control is desired and closed in the morning so as to prevent emanation of the vapour active pyrethroid when insect control is not desired. As the holder is opened, a tongue (28) located on the top (1) strikes the underside of the spindle (26), driving the spindle upwards into the gear teeth (22a) on the underside of the cap (23). These gear teeth (22a) partially rotate the disc (21) in a clockwise direction as the disc gear teeth (22) and cap gear teeth (22b) engage. When the holder is next closed, the gear teeth (22) then lower back onto the gear teeth (22b) located on disc (25), again partially rotating the disc (21) clockwise. Therefore continuous opening and closing of the top translates into rotary motion of the disc (21) and in turn the rotary motion of the graphic display viewed through the window (24).

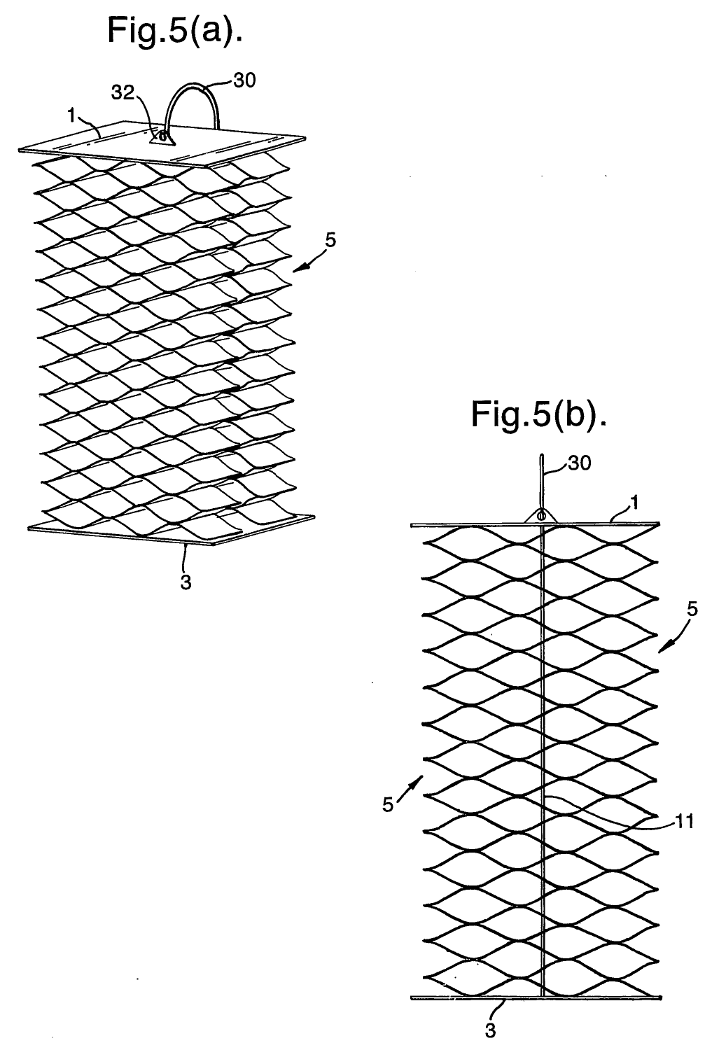

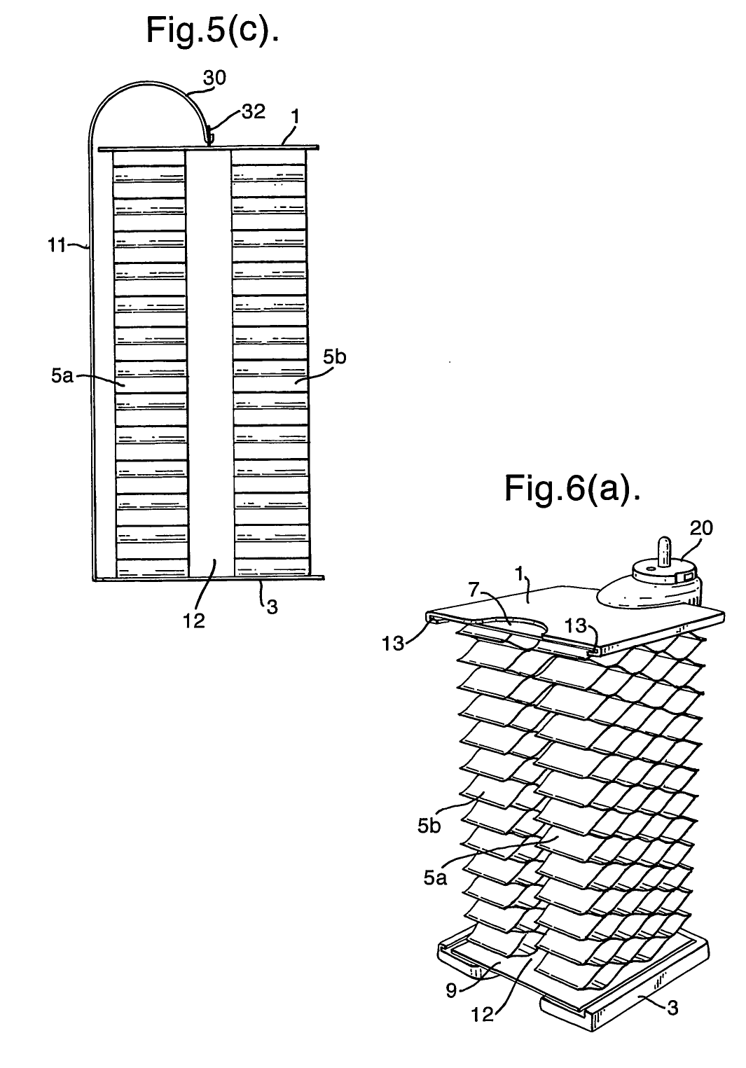

A further embodiment according to the present invention is depicted in FIGS. 5(a) to 5(c). In this embodiment, the packaging means comprises a cellulosic based substrate or matrix (5) that is able to be extended in the vertical direction from a base (3) to a top (1). The base (3) is able to be mounted on a surface, such as a table or ledge, and is attached at one end to the cellulosic based substrate or matrix (5) with the other end of the cellulosic substrate or matrix (5) being attached to the top (1). The top (1) is able to connected to the base (3) and the attached cellulosic based substrate or matrix supported in an open position by means of a vertically extending longitudinal member in the form of a thin rod (11) with a hook (30) at one end. When a user desires emanation of vapour active pyrethroid into the atmosphere, the user extends the cellulosic based substrate or matrix to an open position and maintains it in the open position by hooking a ring (32) located on the top (1) on the hook (30). Conversely, when the user desires no emanation of the vapour active pyrethroid, the user allows the cellulosic based substrate or matrix (5) to retract towards the base (3) by unhooking the top (1) from the hook (30).

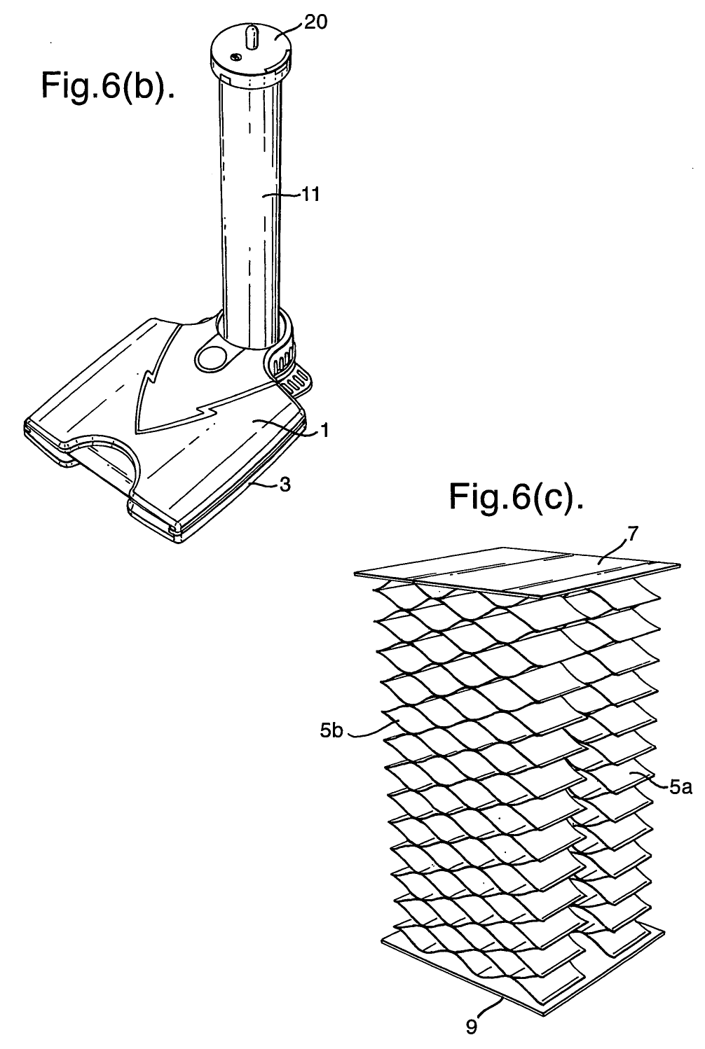

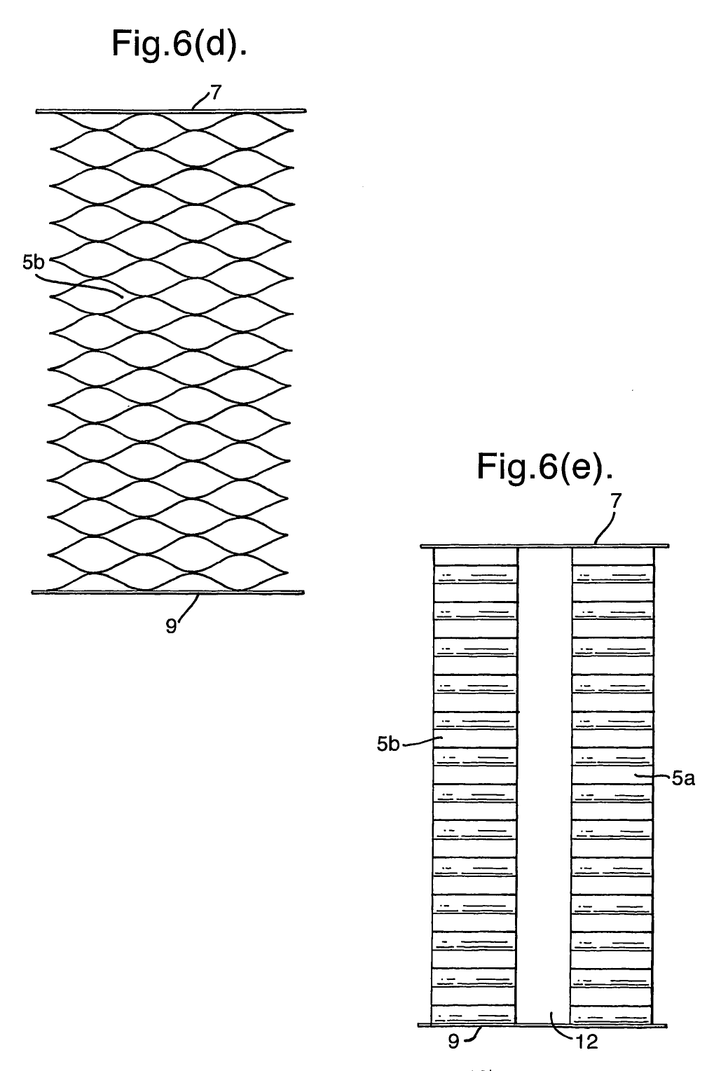

Another aspect of the invention is depicted in FIGS. 6(a) to 6(e) in which according to a preferred embodiment of this aspect, the packaging means comprises a cellulosic based substrate or matrix that is comprised of two discrete parts having substantially identical dimensions of height and width. The inventors have surprisingly found that in this configuration, an increased rate of emanation is observed. The discrete cellulosic based substrate or matrix parts may be positioned within the holder in any orientation, however, in a preferred embodiment, the parts are orientated such that the column (11) and the space (12) between the discrete parts (5a, 5b) are aligned as shown in FIG. 6(a)

Referring to FIGS. 6(a) and 6(b), a packaging means according to the second aspect of the invention is depicted having a top (1) and a base (3) to which a two-part cellulosic based substrate or matrix (5a, 5b) is attached by means of cards (7, 9) that are able to retained with the top (1) and base (3) by sliding motion in slots (13). The packaging means further comprises an indicator (20) which has been described in detail with reference to FIGS. 4(a) to 4(f). The two-part cellulosic based substrate or matrix is also clearly depicted in FIGS. 6(c) to 6(e) attached to cards (7, 9).

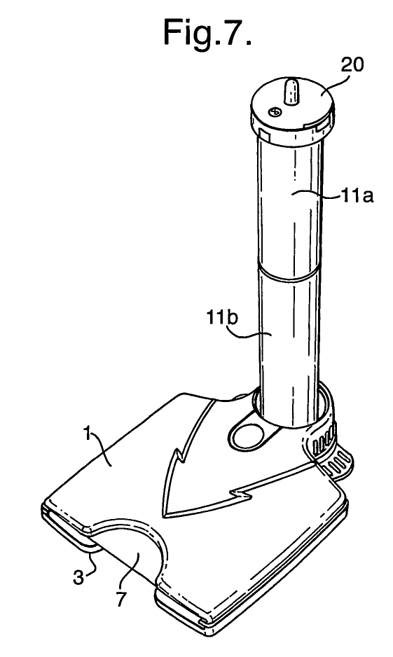

Another preferred embodiment of the invention is depicted in FIG. 7 in which the column (11) is provided to the consumer in two parts (11a, 11b) which once interfitted, are unable to be disassembled. It will be appreciated however that the present invention also provides an alternative embodiment in which the column (11) with parts (11a, 11b) is able to be releasably interfitted such that a consumer is able to assemble or disassemble the column parts (11a and 11b) as desired. In this configuration, the parts (11a, 11b) are, for example, male and female portions that are able to be releasably interfitted.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A packaging means for retaining and releasing at least one vapour active pyrethroid compositions comprising a holder and a cellulosic substrate comprising the vapour active pyrethroid, the holder comprising a top, a base and a longitudinal member vertically extending from between the top and base thereby supporting the top and the base in a spaced-apart relationship, and the cellulosic based substrate or matrix is attached to the top and the base and has a honeycomb configuration and an effective amount of surface area to release a sufficient amount of the vapour active pyrethroid to control flying insects.

2. The packaging means of claim 1 wherein the cellulosic substrate comprise s two or more discrete parts.

3. The packaging means according to claim 1 wherein the cellulosic substrates ratrix is releasably attached to the top or the base, or both.

4. The packaging means according to claim 2 wherein the two parts are of substantially identical dimensions.

5. The packaging means claim 1 wherein the cellulosic substrate has a surface area of about 50-5000 cm² and a height of about 8-23 cm.

6. The packaging means of claim 1 wherein the cellulosic substrate or matrix has a surface area of about 50-5000 cm² and a height of about 17.5 cm.

7. The packaging means of claim 1 wherein the cellulosic substrate has a surface area of about 180-2400 cm² and a height of about 8-23 cm.

8. The packaging means of claim 1 wherein the cellulosic substrate has a surface area of about 180-2400 cm² and a height of about 17.5 cm.

9. The packaging means of claim 1 wherein the cellulosic substrate comprises about 12-260 g-m².

10. The packaging means of claim 1 wherein the cellulosic substrate comprises about 18-40 g-m².

11. The packaging means of claim 1 wherein the cellulosic substrate about 18 g-m².

12. The packaging means of claim 1 wherein the cellulosic substrate comprises the vapour active pyrethroid in an amount of about 2-3000 mg-m⁻² of surface area.

13. The packaging means of claim 1 wherein the cellulosic substrate comprises the vapour active pyrethroid in an amount of about 16-32 mg-m⁻² of surface area.

14. The packaging means of claim 1 wherein the cellulosic substrate comprises the vapour active pyrethroid in an amount of about 130-320 mg-m⁻²of surface area

15. The packaging means of claim 1 wherein the cellulosic substrate comprises the vapour active pyrethroid in an amount of about 48-960 mg-m⁻² of surface area.

16. The packaging means of claim 1 wherein the cellulosic substrate vapour active pyrethroid in an amount of about 390-960 mg-m⁻² of surface area.

17. The packaging means of claim 1 wherein the cellulosic substrate comprises the vapour active pyrethroid in an amount of about 144-2880 m-mg⁻² of surface area.

18. The packaging means of claim 1 wherein the cellulosic substrate comprises the vapour active pyrethroid in an amount of about 1170-2880 mg-m⁻² of surface area.

19. The packaging means of claim 1 wherein the longitudinal member is releasably attachable to the top.

20. The packaging means of claim 1 wherein the longitudinal member is releasably attachable to the base.

21. The packaging means of claim 1 wherein the longitudinal member is releasably attachable to both of the top and base.

22. The packaging means of claim 1 wherein the cellulosic substrate the longitudinal vertically extending member, or both, have a first position and a second position such that they are capable of being extended so that the top and base are in an open state in a first position or collapsed so that the top and base are in a closed state in a second position.

23. The packaging means of claim 22 wherein the open state eases an amount of the vapour active pyrethroid to control flying insects.

24. The packaging means to of claim 22 wherein the closed state substantially seals the cellulosic based substrate releasing a minimal amount of vapour active pyrethroid.

25. The packaging means of claim 22 wherein the top and base are capable of being maintained in an intermediate third position between the open first position and closed second position thereby releasing an amount of vapour active pyrethroid proportional to the amount of surface area of the cellulosic substrate exposed to the atmosphere.

26. The packaging means of claim 2 the longitudinal member vertically extending between the top and the base is a column.

27. The packaging means of claim 26 wherein the column is collapsible by folding at one or more hinged joints.

28. The packaging means of claim 26 wherein the column is comprised of one or more parts and is collapsible by telescopic movement of the one or more parts of the column within the other parts of the column.

29. The packaging means of claim 26 wherein the column is comprised of two or more interfitting parts.

30. The packaging means of claim 26 wherein the column is comprised of two or more releasable interfitting parts.

31. The packaging means of claim 26 wherein the column is comprised of two or more non-releasable interfitting parts.

32. The packaging means of claim 31 wherein the parts are able to be interfitted by means of a slotted configuration wherein each respective part comprises a slot which fits into the slot of another one or more parts.

33. The packaging means of claim 26 wherein the top is adapted to receive the column through an aperture thereby allowing the top to be moved along the column by a sliding motion so that the holder is able to be opened by sliding the top away from the base or closed by sliding the top towards the base.

34. The packaging means of claim 1 wherein the longitudinal member vertically extending between the top and the base is a spring.

35. The packaging means of claim 34 wherein the spring is compressed in the resting state so that the cellulosic substrate is maintained in the first position in the absence of an externally applied force.

36. The packaging means of claim 34 wherein the spring is uncompressed in the resting state so that the cellulosic substrate is maintained in the second extended state in the absence of an externally applied force.

37. The packaging means of claim 1 wherein the holder and cellulosic substrate or matrix are adapted to allow the cellulosic matrix substrate to be releasably retained in the holder and replaced as required.

38. The packaging means of claim 37 wherein the holder comprises a slot within the periphery of each of the top and base and the cellulosic substrate or matrix comprises a card on each of its ends, wherein the cards are slidable within the slots thereby allowing the cellulosic based substrate to be releasably retained in the holder.

38. The packaging means of claim 1 wherein the cellulosic substrate is adapted to receive the longitudinal member through an aperture thereby retaining the cellulosic substrate or matrix between the top and base.

40. The packaging means of claim 1 wherein the cellulosic substrate is able to be replaced by detaching the top or base, or both, from the longitudinal member, mounting the cellulosic substrate about the longitudinal member, and reattaching the top or base, or both, to the longitudinal member.

41. The packaging means of claim 1 wherein the cellulosic substrate or matrix is removable for replacement without a need to detach either the top or base from the longitudinal member.

42. The packaging means of claim 1 wherein the cellulosic substrate is removable for replacement while the top and base are in a closed position.

43. The packaging means of claim 1 wherein the longitudinal member is capable of being stored within the packaging means when the top and base are in a closed position.

44. The packaging means of claim 1 wherein the top further comprises a protruding rim and wherein the base comprises a means for engaging the protruding rim to substantially retain the vapour active pyrethroid when the top and base are in the closed state.

45. The packaging means of claim 44 wherein the top is a lid.

46. The packaging means of claim 1 wherein the means further comprises an end-of-life (EOL) indicator comprising a counter, an indicator display located on the counter and a gear mechanism adapted to rotate the counter one increment each time the packaging means is extended from a first closed position to a second open position , such that a user is able to ascertain from the display when the packaging means is substantially depleted in vapour active pyrethroid thereby having reached its EOL.

47. The packaging means according to claim 46 wherein the indicator display is a numeric or colour graphic display.

48. The packaging means according to claim 1 wherein the cellulosic substrate is attached to the top and base, wherein the base is able to be surface mounted and is connected to the longitudinal member having a hook on its end, and wherein the cellulosic substrate is able to be extended and supported in the extended state by attachment of the top to the hook.

49. A method of releasing a vapour active pyrethroid into the atmosphere by the use of a packaging means of claim 1.

50. The method according to claim 49 for controlling any one of mosquitoes, flies, gnats, sandflies, midges, moths.

51. The method according to claim 49 for controlling mosquitoes.

52-83. (canceled)
